(19) United States
(12) Patent Application Publication
(10) Pub. No.: US 2013/0309136 A1
(43) Pub. Date: Nov. 21, 2013

(54) SAMPLE PROCESSING METHODS AND SYSTEMS TO COLLECT AND DILUTE A BIOLOGICAL SAMPLE

(71) Applicant: Boston Microfluidics, Cambridge, MA (US)

(72) Inventors: Brandon T. Johnson, Somerville, MA (US); Kate E. Christian, Cambridge, MA (US); Glen H. Verner, Powell, OH (US); Daniel Morgan, Salem, MA (US)

(73) Assignee: Boston Microfluidics, Cambridge, MA (US)

(21) Appl. No.: 13/854,718

(22) Filed: Apr. 1, 2013

Related U.S. Application Data
(60) Provisional application No. 61/618,195, filed on Mar. 30, 2012.
(60) Provisional application No. 61/672,854, filed on Jul. 18, 2012.

(51) Int. Cl. G01N 1/38

(52) U.S. Cl. CPC G01N 1/38
USPC 422/82.05; 422/521; 422/520; 422/513; 422/522

(57) ABSTRACT

Sample processing methods and systems to collect and dilute a biological sample. A device collects a predetermined volume of sample in one chamber, seals the chamber upon activation, and mixes the sample with a predetermined volume of reagent.

### RELATED APPLICATIONS

This application claims the benefit of U.S. provisional patent application number 61/618,195, filed Mar. 30, 2012, which is incorporated herein by reference in its entirety.

### BACKGROUND

Conventional devices to collect and dilute a biological sample are generally not portable or mechanically actuated.

### BRIEF DESCRIPTION OF THE DRAWINGS/FIGURES

FIG. 1A is a cut-away side-view of a sample processing device to collect and dilute a biological sample.

FIG. 1B is a cross-sectional top-down view of the device of FIG. 1, corresponding to a view 1B in FIG. 1A.

FIG. 2A is cut-away side-view of a portion of another device to collect and dilute a biological sample.

FIG. 2B illustrates example features of the device of FIG. 2A.

FIG. 2C illustrates example features of the device of FIG. 2A.

FIG. 2D illustrates example features of the device of FIG. 2A.

FIG. 2E illustrates example features of the device of FIG. 2A.

FIG. 2F illustrates example features of the device of FIG. 2A.

FIG. 3A is top-down view of another device to collect, dilute, and test a biological sample.

FIG. 3B is a cut-away side-view of a portion of the device of FIG. 3A.

FIG. 3C is a cut-away top-down view of a portion of the device of FIG. 3A.

FIG. 3D is a cross-sectional view of a portion of the device of FIG. 3A.

FIG. 4A is a perspective view of another sample processing device to collect and dilute a biological sample.

FIG. 4B illustrates example features of the device of FIG. 4A.

FIG. 4C illustrates example features of the device of FIG. 4A.

FIG. 5 is a cut-away side-view of another sample processing device to collect and dilute a biological sample.

FIG. 6 is a cut-away side view of a sample processing device having a capillary tube port to receive a capillary tube.

FIG. 7A is a cut-away side-view of a sample processing device to receive a syringe.

FIG. 7B is a cut-away side-view of the device of FIG. 7A in an open position.

FIG. 7C is a top-down view of the device of FIG. 7A in the open position.

FIG. 8A is cut-away side-view of another device to collect and dilute a biological sample.

FIG. 8B is a cut-away side-view of a cap to seal a fluid outlet of the device of

FIG. 8A.

In the drawings, the leftmost digit(s) of a reference number may identify the drawing in which the reference number first appears.

### DETAILED DESCRIPTION

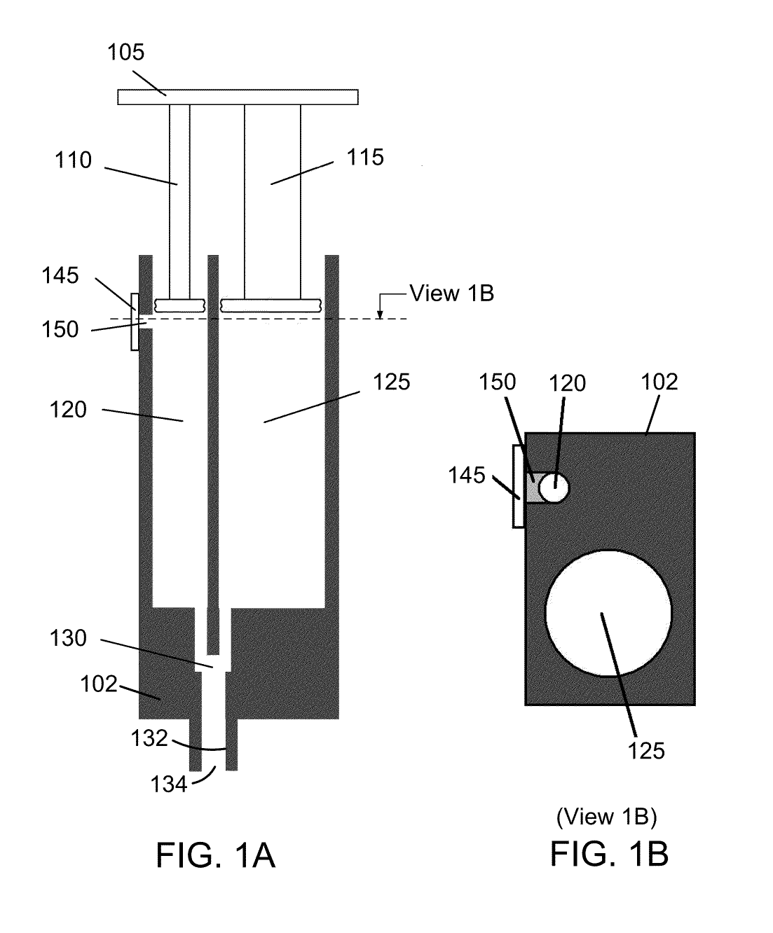

FIG. 1A is a cut-away side-view of a sample processing device 100 to collect and dilute a biological sample.

FIG. 1B is a cross-sectional top-down view of device 100, corresponding to a view 1B in FIG. 1A.

Device 100 includes a housing 102 having an inlet 150 and a first chamber 120, also referred to herein as a sample chamber 120, to collect or receive a biological sample through inlet 150. Device 100 may be configured to collect or receive a predetermined volume of the biological sample in sample chamber 120.

Device 100 further includes a reagent chamber 125, which may be pre-loaded with a reagent.

Device 100 further includes a first plunger 110 structured to slide into sample chamber 120, and a second plunger 115 structured to slide into reagent chamber 125. Device 100 further includes an external mechanical actuator 105 to control first and second plungers 110 and 115.

External actuator 105 may be configured to simultaneously move plungers 110 and 115, to cause plunger 110 to move the biological sample from sample chamber 120 through a fluid outlet of chamber 120, and to cause plunger 115 to move the reagent from reagent chamber 125 through a fluid outlet of chamber 125.

Device 100 may be configured to combine and/or mix the biological sample and reagent in a mixing chamber 130, and to dispense the combined biological sample and reagent through a fluid path 132 to a fluid outlet 134.

Fluid outlet 134 may correspond to a fluid outlet of device 100, and may be configured to receive an attachment, such to provide the combined biological sample and reagent to one or more other devices and/or tools, such as for processing and/or diagnostics. The one or more other devices and/or tools may include, without limitation, a cassette and/or lateral flow strip.

Alternatively, or additionally, housing 102 may include an assay region to receive fluid from fluid path 132 and/or fluid outlet 134. The assay region may include, without limitation, a lateral flow strip.

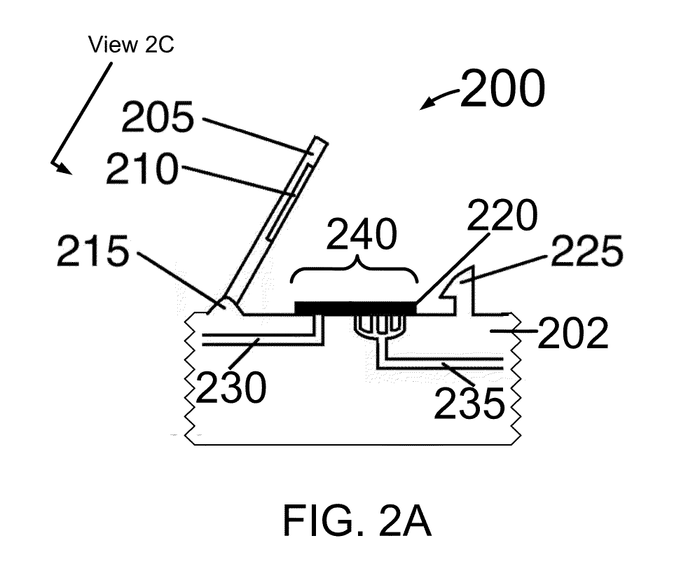

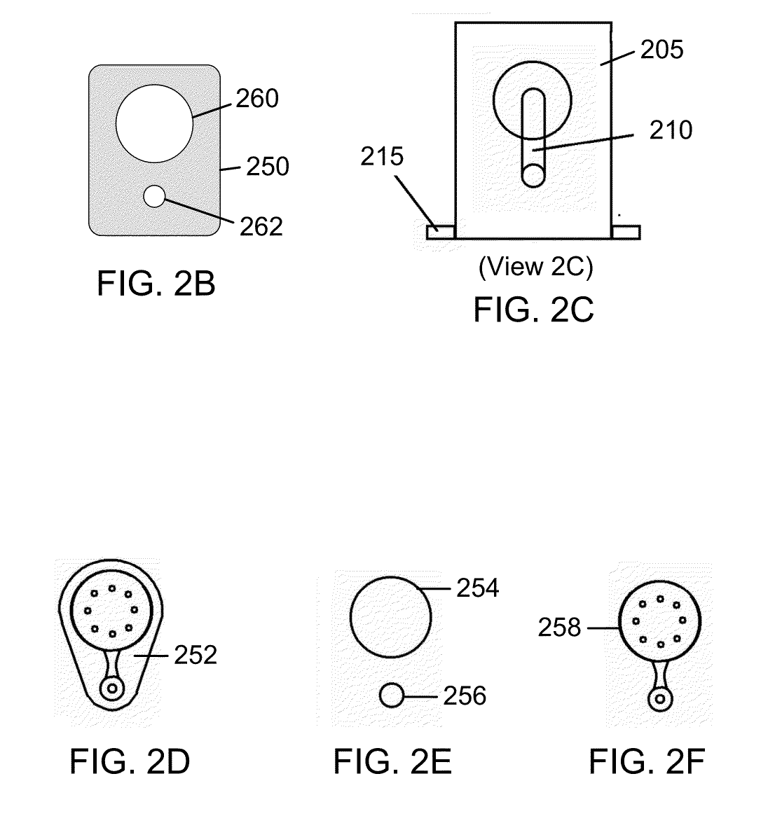

Device 100 may be configured to seal sample chamber 120 upon activation of external actuator 105. Device 100 may include, for example, an exterior cover to seal inlet 150 and prevent the sample from exiting device 100 through inlet 150 upon activation external actuator 105, such as described below with reference to FIG. 2D.

Device 100 may be configured to combine and/or mix the biological sample from sample chamber 120 with a predetermined volume of liquid reagent from reagent chamber 125 in mixing chamber 130. Device 100 may be further configured to combine and/or mix the biological sample and the liquid reagent from reagent in accordance with a pre-determined ratio. In FIG. 1B, for example, cross-sectional areas of sample chamber 120 and reagent chamber 125 sized or dimensioned to provide a desired reagent to sample ratio.

In some embodiments sample chamber 120 and reagent chamber 125 are positioned in series with respect to each other.

Device 100 may further include a filter, which may be positioned within a filter area proximate to sample inlet 150. In the examples of FIGS. 1A and 1B, device 100 includes a filter 145.

Filter 145 may be structured or configured to filter or remove unwanted material from a collected sample such as, for example, to remove red or white blood cells from a blood sample. A red blood filter may be useful to provide blood plasma to sample chamber 120 through inlet 150. Filter 145 may include a pad made from a material selected from the following: nitrocellulose, glass fiber, nylon, and/or other synthetic(s) material and/or compound. Filter 145 may include one or more reagents thereon and/or therein, (e.g., dried on filter 145), to contact and/or treat the biological sample.

Device 100 may include a wick within inlet 150, which may be in contact with filter 145 to draw liquid through filter 145 into sample chamber 120.

Device 100 may include a capillary tube between filter 145 and sample chamber 120 to collect a predetermined volume of a filtered biological sample from filter 145. Device 100 may be may be configured to fill the capillary tube and retain any excess biological sample in the filter area.

FIG. 2A is cut-away side-view of a portion of a device 200 to collect and dilute a biological sample. FIGS. 2B through 2F illustrate example features of device 200. One or more features described below with reference to FIGS. 2A through 2F may be combined with one or more features described above with respect to device 100. Device 100 is not, however, limited to the examples of FIGS. 2A through 2F.

In FIG. 2A, device 200 includes a housing 202 having a sample receiving region 240, a fluid inlet 230 to sample receiving region 240, and a fluid outlet 235 from sample receiving region 240. Fluid inlet 230 may be configured to provide a reagent from a reagent chamber and/or a wash solution to sample receiving region 240.

Sample receiving region 240 may include a sample well.

Device 200 further includes a door or cover 205 to enclose sample receiving region 240. Door 205, when closed, may form one or more chambers within and/or adjacent to sample receiving region 240. Cover 205 may have a fluid path 210 to provide fluid from fluid inlet 230 to sample receiving region 240 when in a closed position. Fluid path 210 may be configured to distribute the fluid over an area of sample receiving region 240.

In the example of FIG. 2A, device 200 further includes a hinge 215 to hingedly connect cover 205 to housing 202. Also in the example of FIG. 2A, housing 202 includes a latch 225 to retain cover 205 when cover 205 is placed in the closed position. FIG. 2C is a top-down view of device 200 corresponding to a view 2C in FIG. 2A, illustrating door 205, fluid path 210, and hinge 215. Device 200 is not, however, limited to a hinged cover.

Housing 202 may have a sealing surface 220 to seal sample receiving region 240 when cover 205 is in the closed position. Sealing surface 220 may include a gasket 250 in FIG. 2B, a deformable surface 252 in FIG. 2D, 0-rings 254 and 256 in FIG. 2E, and/or a deformable surface 258 in FIG. 2F. In FIG. 2B, gasket 250 has an opening 260 corresponding to sample receiving region 240 in FIG. 2A, and an opening 262 corresponding to fluid path 210 in FIG. 2A. Similar openings are illustrated in FIGS. 2D, 2E, and 2F.

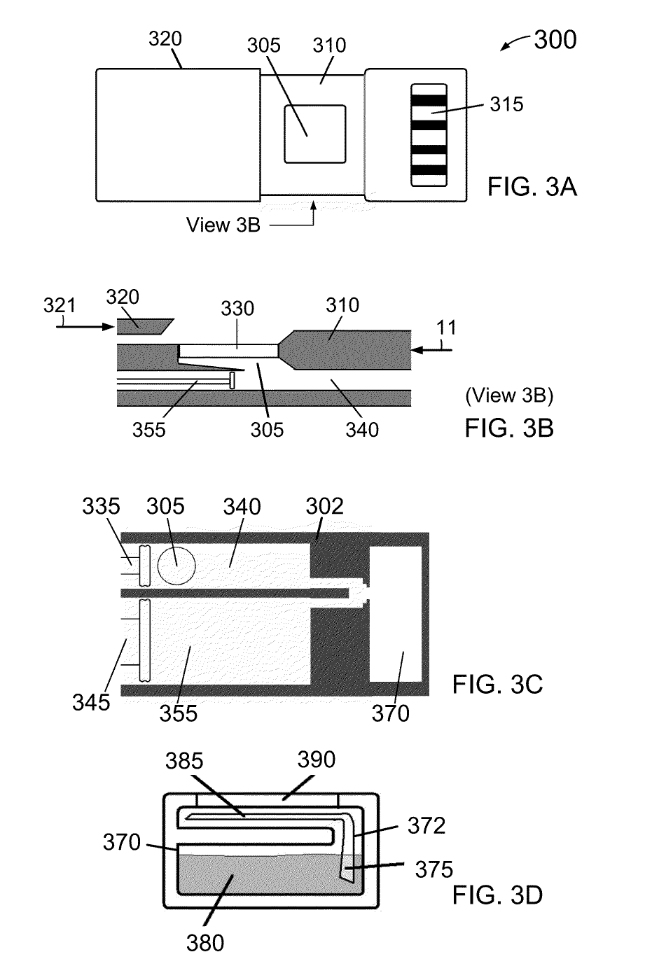

FIG. 3A is top-down view of a device 300 to collect, dilute, and test a biological sample. Device 300 includes a housing having a sample inlet 305, a sealing surface 310, a sliding surface 320, and a lateral flow test 315. Sealing surface 310 and sliding surface 320 may be configured to slide toward one-another to seal sample inlet 305 and/or to activate device 300, such as described in one or more examples below.

FIG. 3B is a cut-away side-view of device 300, corresponding to a view 3B in FIG. 3A, in which sealing surface 310 and sliding surface 320 are configured to slide toward one-another in the directions of corresponding arrows 311 and 321, to seal sample collection area 305 and to activate or control a sample plunger 335 to move a sample from sample inlet 305 into and/or through a sample chamber 340.

In the example of FIG. 3B, device 300 further includes a sample collection pad 330 within sample inlet 305.

FIG. 3C is a cut-away top-down view of a portion of device 300, including sample inlet 305, sample plunger 335, and sample chamber 340 within a housing 302. Housing 302 further includes a reagent chamber 350 and a reagent plunger 345. Sample plunger 335 and reagent plunger 345 may be mechanically linked to the closing of device 300, and may be configured to activate when sealing surface 310 and sliding surface 320 (FIGS. 3A and 3B) are pressed together to seal sample inlet 305.

Plungers 335 and 345 may be configured to move contents of sample chamber 340 and reagent chamber 355, respectively, such as described in one or more examples herein. In the example of FIG. 3C, housing 302 further includes a collection chamber 370 to receive, combine, and/or mix contents of sample chamber 340 with contents of chamber 355.

FIG. 3D is a cross-sectional view of device 300 (side-view or end-view), in which collection chamber 370 is illustrated with a mixture 380 of a liquid reagent and sample. In the example of FIG. 3D, housing 302 further includes a fluid passage 372 between collection chamber 370 and a test region 385, and a wicking material 375 within fluid passage 372 to wick mixture 380 to test region 385. Lateral flow test 315 (FIG. 3A) may be positioned within test region 385 to permit viewing of test results through a window 390.

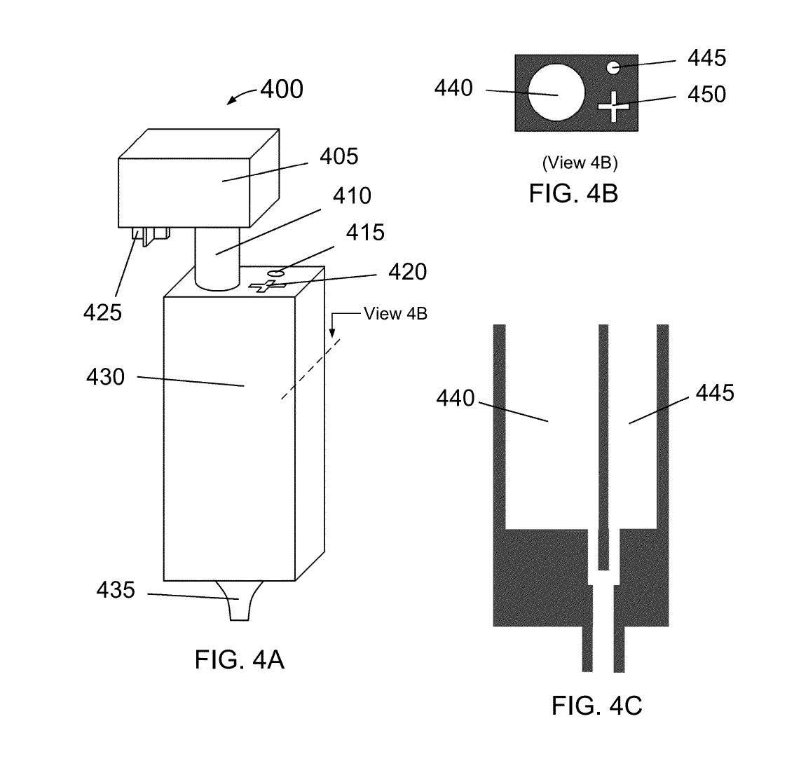

FIG. 4A is a perspective view of a sample processing device 400 to collect and dilute a biological sample. FIGS. 4B and 4C illustrate example features of device 400.

Device 400 includes a top portion 405 having an alignment key 425 extending therefrom, body portion 430 having a key slot 420 to receive key 425, a sample port 415 to receive a sample, a rotatable plunger 410, and a nozzle 435.

Top portion 405 is rotatable about plunger 410 to align key 425 with slot 420. When key 425 is aligned with slot 420, top portion 405 may be pressed towards body portion 430 to activate plunger 410.

When key 425 is aligned with slot 420, sample inlet 415 may be aligned with a sealing surface, tube, and/or plunger within body portion 405 to provide a sealed chamber.

FIG. 4B is top-down cross-sectional view of body portion 430, corresponding to view 4B in FIG. 4A. In FIG. 4B, body portion 430 has a liquid reagent chamber 440 dimensioned to accommodate plunger 410, a sample chamber 445, and an opening 450 dimensioned to accommodate key 425.

FIG. 4C is a cut-away side-view of body portion 430, depicting liquid reagent chamber 440 and sample chamber 445.

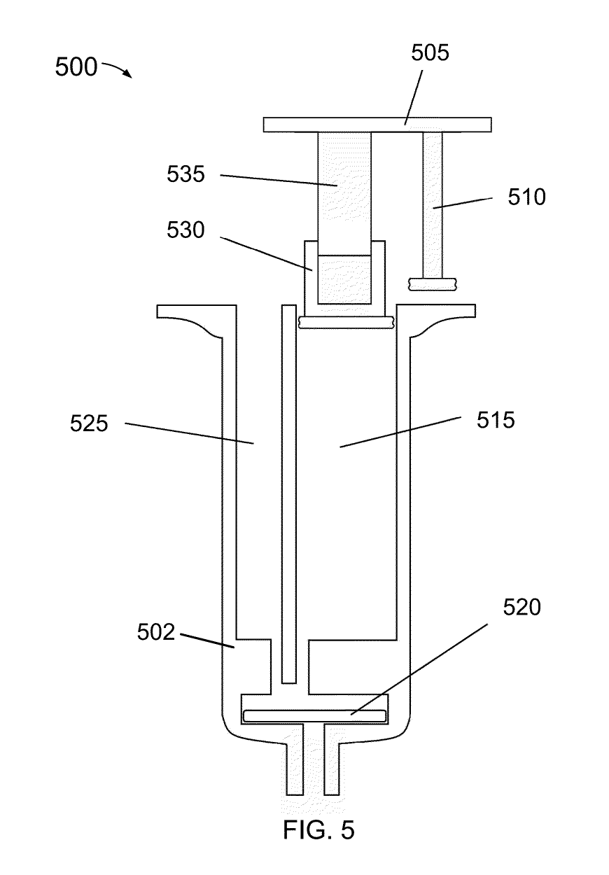

FIG. 5 is a cut-away side-view of a sample processing device 500 to collect and dilute a biological sample. Device 500 includes a housing 502 having a liquid reagent chamber 515 and a sample chamber 525, illustrated herein in a parallel configuration. Device 500 further includes a filter 520 downstream of parallel chambers 525 and 515. Device 500 further includes a first plunger, including a nested plunger upper portion 535 and a nested plunger lower portion 530 in liquid reagent chamber 515. Device 500 further includes a second plunger 510 that is rotatable into sample chamber 525, such as after addition of a sample. Nested plunger portions 535 and 530, and plunger 510 are mechanically linked by an actuator portion 505.

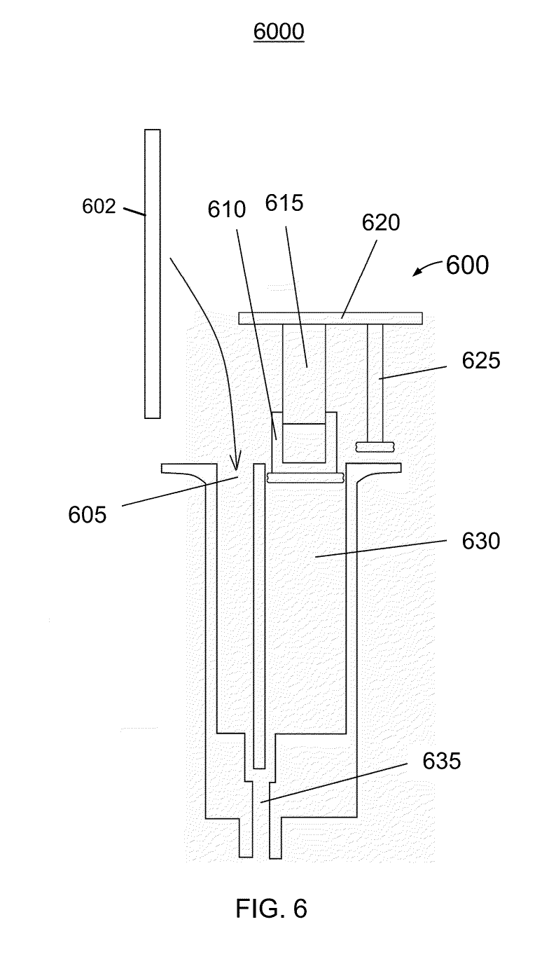

FIG. 6 is a cut-away side view of a sample processing device 600 having a capillary tube port 605 to receive a capillary tube 602. Capillary tube 602 may be configured to collect or receive a sample for transfer to device 600.

Device 600 includes a sample plunger 625, a liquid reagent plunger 610 and a corresponding nested plunger 615 dimensioned for a liquid reagent chamber 630. Device 600 further includes a mechanical actuator 620 to link liquid reagent plunger 615 to sample plunger 625.

Mechanical actuator 620 is twistable to align plunger 625 with capillary port 605.

When plunger 625 is aligned with capillary port 605, actuator 620 is depressible to dispense sample from capillary tube 602 and liquid reagent from liquid reagent chamber 630, and through a fluid outlet 635 where the sample and the liquid reagent mix. The sample may be dispensed from capillary tube 602 by plunger 625, alone and/or in combination with air pressure and/or additional liquid.

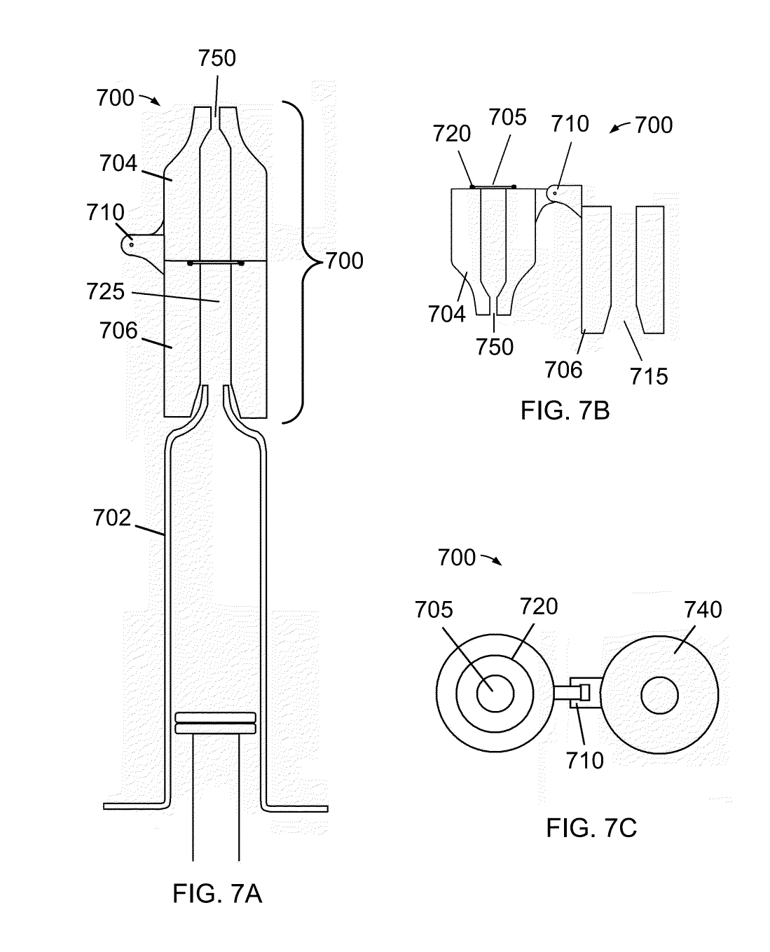

FIG. 7A is a cut-away side-view of a sample processing device 700 to receive a syringe 702. Device 700 includes first and second housing portions 704 and 706, respectively, hingedly connected to one another with a hinge 710. In the example of FIG. 7A, device 700 is illustrated in a closed position.

FIG. 7B is a cut-away side-view of device 700 in an open position.

FIG. 7C is a top-down view of device 700 in the open position.

Device 700 includes first and second housing portions 704 and 706, respectively. Device 700 further includes a sample collection area 705 and a syringe inlet 715 to receive syringe 702.

In the open position, sample collection area 705 is exposed to receive a sample.

In the closed position, a sealing surface 720 first housing portion 704 contacts a surface 740 of second housing portion 706 to enclose sample collection area 705, and device 700 provides a fluid path 725 between syringe inlet 715 and a fluid outlet 750, through sample collection area 705.

To operate, sample is added to sample area 705 while device 700 is in the open position. Device 700 may then be closed latched to enclose and seal sample collection area 705. When syringe is inserted at syringe inlet 715, a liquid within syringe 715 may dispensed through fluid path 725 and a corresponding product may be collected at fluid outlet 750.

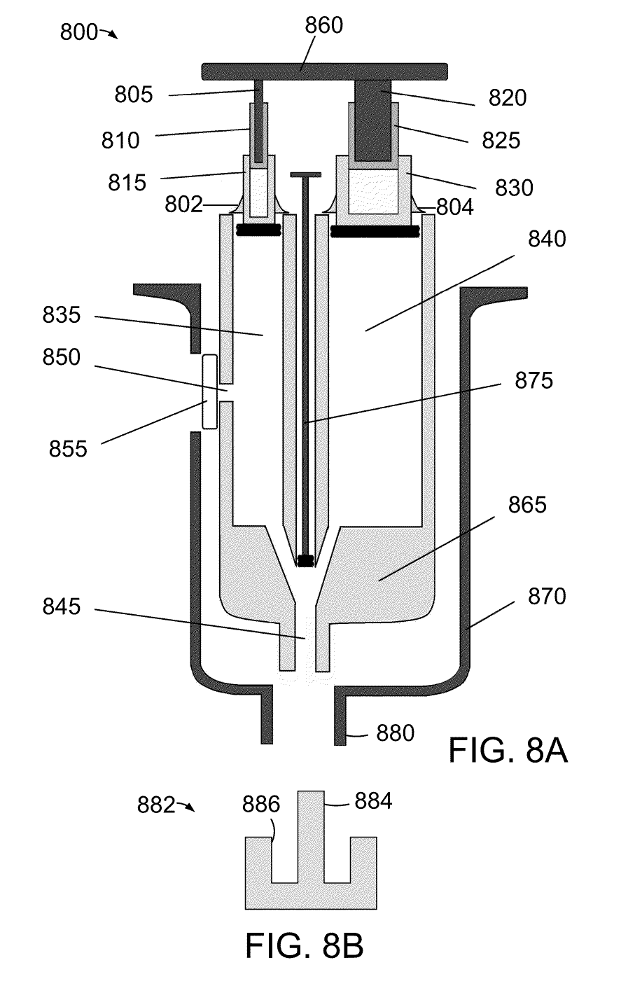

FIG. 8A is cut-away side-view of a device 800 to collect and dilute a biological sample.

Device 800 includes an outer housing portion 870, and an inner housing portion 868 having a sample chamber 835 and liquid reagent chamber 840.

Device 800 is configured to mix sample from chamber 835 and liquid reagent from chamber 840 at a fluid outlet 845.

There is a sample inlet 850 and a sample filter 855.

Device 800 may include a sample filter 855, such as described in one or more examples herein.

Device 800 may include one or more nested or multistage plungers to initiate multiple mechanical actions. In the example of FIG. 8, a sample plunger includes a plunger portion 805 to nest within a plunger portion 810, to nest within a plunger portion 815. Also in FIG. 8, a liquid reagent plunger includes a plunger portion 820 to nest within a plunger portion 825, to nest within a plunger portion 830.

Device 800 further includes a mechanical actuator 860 to link the sample and reagent plungers to dispense sample and reagent proportionally. In FIG. 8, mechanical actuator 860 is configured to move internal housing portion 865 relative to outer housing portion 870, to close or seal sample inlet 850 against an inner wall of outer housing portion 870, and provide a sealed chamber.

Plunger portion 815 may include a retractable arm 802 to prevent plunger portion 815 from inserting further into sample chamber 835 until housing portions 865 and 870 are positioned to seal sample inlet 850 as described. Similarly, plunger portion 830 may include a retractable arm 804 to prevent plunger portion 830 from inserting further into reagent chamber 840 until sample inlet 850 is sealed.

Device 800 may include a plunger 875 to clear liquid from fluid outlet 845 after sample chamber 835 and reagent chamber 840 are emptied. This may permit greater volume output from each run.

In some embodiments a length of sample collection chamber 835 is positioned next to a length of reagent chamber 840. Where the lengths are the same, the sample and reagent solutions may dispense at a proportional rate to provide a solution that is evenly mixed as it is dispensed.

In some embodiments either sample chamber 835 and/or reagent chamber 840 may have multiple stages to release first one fluid and then another fluid.

In some embodiments one or more plungers is mechanically linked to one or more covers. In such an embodiment, activation of the plunger(s) also moves the corresponding cover(s) into place to close or seal sample collection area 885 to prevent contamination or leaking.

Device 800 may include a cover or cap to plug or seal a fluid output 845 prior to use, such as described below with reference to FIG. 8B.

FIG. 8B is a cut-away side-view of a cap 882, including a plug 884 to seal fluid outlet 845 of device 800 in FIG. 8A, and a cavity or well 886 to receive a wall 880 extending from outer housing portion 870 of device 800. Cap 882 is not necessarily illustrated in proportion to features of device 800 in FIG. 8A.

Plug 884, or a portion thereof may be configured to insert snugly within fluid outlet 845 in FIG. 8A, and/or to seal against a surface inner housing 865 in FIG. 8A. A portion of plug 884 may be configured to insert snugly within an opening 881 of outer housing portion 870 in FIG. 8. Cap 882 may be used plug fluid outlet 845 prior to running or activating device 800, and may be removed before use or activation of device 800. Cap 882 may be configured to prevent accidental activation of device 800.

Examples are provided herein in which a device is configured to dispense fluids from a sample chamber and a reagent chamber in parallel with one another. Methods and systems disclosed herein are not, however, limited to parallel arrangements and, unless specified otherwise herein, such devices may be configured to dispense fluids from a sample chamber and a reagent chamber serially.

Methods and systems are disclosed herein with the aid of functional building blocks illustrating the functions, features, and relationships thereof. At least some of the boundaries of these functional building blocks have been arbitrarily defined herein for the convenience of the description. Alternate boundaries may be defined so long as the specified functions and relationships thereof are appropriately performed.

While various embodiments are disclosed herein, it should be understood that they have been presented by way of example only, and not limitation. It will be apparent to persons skilled in the relevant art that various changes in form and detail may be made therein without departing from the spirit and scope of the methods and systems disclosed herein. Thus, the breadth and scope of the claims should not be limited by any of the example embodiments disclosed herein.

What is claimed is:

1. A system comprising:
a portable housing having a sample region to receive a biological sample, a reagent region to hold a reagent, a fluid outlet, and one or more fluid paths amongst the sample region, the reagent region, and the fluid outlet; and
a mechanically actuated fluid controller to dispense fluid from the sample region and the reagent region to the fluid outlet.

2. The system of claim 1, wherein the housing and the mechanically actuated fluid controller are configured to dispense the biological sample at a first rate and to dispense the reagent at a second rate that is proportional to the first rate.

3. The system of claim 1, wherein the portable housing and the mechanically actuated fluid controller are configured to dispense the biological sample and the reagent based on a pre-determined ratio.

4. The system of claim 1, wherein the sample region includes one or more sample chambers to receive the biological sample.

5. The system of claim 1, wherein the sample region includes a capillary tube.

6. The system of claim 1, wherein the housing has an opening through an end portion to receive the biological sample.

7. The system of claim 1, wherein the housing has an opening through a body portion to receive the biological sample.

8. The system of claim 1, further including a filter positioned in the sample region to filter the biological sample.

9. The system of claim 1, wherein the sample region includes a sample chamber, a sample well to receive the biological sample, and a fluid path to provide the biological sample from the sample well to the sample chamber.

10. The system of claim 9, wherein the sample well is configured to retain excess biological sample to prevent over-filling of the sample chamber.

11. The system of claim 1, wherein:
the sample region is configured to receive a capillary tube having the biological sample therein;
the capillary tube is configured to receive the biological sample prior to placement of the capillary tube within the sample region; and
the mechanical actuator is configured to dispense the biological sample from the capillary tube when the capillary tube is positioned within the sample region with the biological sample therein.

12. The system of claim 1, wherein the sample region is exposed when the device is in an open configuration, and wherein the sample region is a sealed chamber when the device is in a closed configuration.

13. The system of claim 1, further including a movable cover to seal the sample region.

14. The system of claim 13, wherein the cover has a fluid channel to provide reagent fluid from the reagent region to the sample region when the cover is in a closed position.

15. The system of claim 13, wherein the cover is configured to snap into a closed position to form a seal with a gasket.

16. The system of claim 1, wherein the reagent region is configured to receive the biological sample.

17. The system of claim 1, wherein the reagent region includes a reagent chamber.

18. The system of claim 1, wherein the reagent region includes multiple reagent chambers, and wherein the housing and the mechanically actuated fluid controller are configured to dispense reagent from the multiple reagent chambers at corresponding stages.

19. The system of claim 1, wherein the reagent region includes multiple reagent chambers, and wherein the housing and the mechanically actuated fluid controller are configured to dispense reagent from the multiple reagent chambers through corresponding fluid paths.

20. The system of claim 1, wherein the reagent region includes a reagent chamber divided into multiple chambers.

21. The system of claim 2, wherein the housing and the mechanically actuated fluid controller are configured to dispense the biological sample and the reagent in proportion to one another with respect to less than all of the reagent.

22. The system of claim 21, wherein the housing and the mechanically actuated fluid controller are configured to dispense the biological sample and a first portion of the reagent in proportion to one another, and to use a second portion of the liquid regent as a wash.

23. The system of claim 21, wherein the housing and the mechanically actuated fluid controller are configured to dispense the biological sample and a first portion of the reagent in proportion to one another, and to use a second portion of the liquid regent as a pre-wash.

24. The system of claim 21, wherein the housing and the mechanically actuated fluid controller are configured to dispense the biological sample and a first portion of the reagent in proportion to one another, to use a second portion of the liquid regent as a pre-wash, and to use a third portion of the liquid as a wash.

25. The system of claim 2, wherein the fluid controller includes at least two fluid controllers that are mechanically linked to one another.

26. The system of claim 2, wherein the fluid controller includes at least two fluid controllers of different sizes that are mechanically linked to one another.

27. The system of claim 2, further including a rotatable mechanical actuator to unlock the fluid controller when rotated into a pre-determined position.

28. The system of claim 2, further including a mechanically-releasable lock to preclude actuation of the fluid controller when engaged.

29. The system of claim 2, wherein the fluid controller includes multiple nested portions to provide staged actions as the fluid controller is moved from a first position to a second position.

30. The system of claim 29, wherein the nested portions include a portion to activate another fluid controller to clear any remaining liquid from the fluid outlet.

31. The system of claim 2, wherein the fluid controller includes a plunger.

32. The system of claim 1, wherein the housing and the mechanically actuated fluid controller are configured to dispense fluid through the fluid outlet into a container that is configured to receive and transport the fluid.

33. The system of claim 32, wherein the housing is configured to releasably attach to the container.

34. The system of claim 1, wherein the fluid outlet is configured to provide a mixture of the biological sample and the reagent to a diagnostic test device.

35. The system of claim 1, wherein the housing further includes an assay region to receive the fluid from the fluid outlet.

36. The system of claim 35, wherein the housing further a window to permit viewing of at least a portion of the assay region.

37. The system of claim 35, further including a lateral flow strip within the assay region, wherein the window is configured to permit viewing of at least a portion of the lateral flow strip from outside the housing.

38. The system of claim 1, further including a filter within a fluid path to the fluid outlet.

39. The system of claim 1, wherein the housing further has a mixing region within a fluid path to the fluid outlet to mix the biological sample and the reagent.

40. The system of claim 39, wherein the reagent region is within the mixing region.

41. The system of claim 39, wherein the housing has grooves formed within a wall of the mixing region.

42. The system of claim 39, further including balls within the mixing region.

43. The system of claim 1, further including a removable cap to seal the fluid outlet.

44. The system of claim 1, wherein the housing has a sample port to receive a tip of a syringe, and wherein the housing further includes a fluid path from the sample port to the sample region to provide reagent from the syringe to the sample region.

45. The system of claim 44, wherein the reagent region is within the sample region.

46. The system of claim 45, wherein the reagent region includes a membrane within the sample region, and wherein the membrane includes the reagent.

47. The system of claim 1, further including a mechanical actuator to enclose the sample region and activate the fluid controller upon actuation when physical force is applied to the mechanical actuator.
